(19) United States
(12) Patent Application Publication
(10) Pub. No.: US 2005/0249630 A1
(43) Pub. Date: Nov. 10, 2005

(54) Ultraviolet air purifier

(76) Inventors: Olubunmi Ayodele Odumuye, Minneapolis, MN (US); Hyo Keun Ahn, Woodbury, MN (US); Patrick Charles Cronin, Burnsville, MN (US); William Noe, Brooklyn Park, MN (US); Bruce M. Peterson, Alexandria, MN (US); Nicholas Paul Velander, Minneapolis, MN (US); Matthew Carl Zehrer, Lake Elmo, MN (US)

Correspondence Address: LEFFERT JAY & POLGLAZE, P.A., P.O. BOX 581009, MINNEAPOLIS, MN, 55458-1009, US

(21) Appl. No.: 10/840,663

(22) Filed: May 6, 2004

(51) Int. Cl. B32B 5/02

(52) U.S. Cl. 422/4; 422/121

(57) ABSTRACT

An ultraviolet (UV) device increases turbulent air flow in a duct, decreasing air flow velocity in the vicinity of the UV device, increasing exposure time of contaminants to UV light, and improving kill rates for contaminants. An arrangement of UV light sources increases UV intensity along the axis of fluid flow.

### FIELD

The present invention relates generally to air purifiers and in particular the present invention relates to duct mounted ultraviolet air purifiers.

### BACKGROUND

Fresh air is considered to be beneficial. In an indoor situation, air can become contaminated with household chemical fumes, dust particles, odors from pets and tobacco products, pollen, dust mites, bacteria, viruses, molds, spores, fungi, and the like. Every house has some type of contaminant. As with any contaminant, exposure to the contaminant can cause health issues including illness, infections, and discomfort.

Air purifiers for use in home and other ducts have been used to purify air passing through the duct. Such air purifiers have taken many forms, including by way of example only and not by way of limitation, dust filters in furnaces, other mechanical filter systems placed in-duct, ultraviolet light purifiers, and the like. Mechanical filters remove some contaminants by creating a barrier to passage, and trapping the contaminant in the filter. However, mechanical filters decrease air flow, and cannot be manufactured economically to trap all contaminants, as some contaminants are particularly small.

Fir this reason, more effective air purification typically uses other techniques, such as ultraviolet light exposure to living type contaminants to kill the contaminants. Ultraviolet light having a wavelength shorter than about 300 nanometers has been found to be very effective in killing bacteria and viruses. Kill rates are dependent upon a number of factors, including light wavelength, light intensity, time of contact, and distance from the light source. The longer a contaminant is exposed to UV light, the higher the kill rate. The higher the intensity of the UV light, the higher the kill rate. Ultraviolet light in the C bandwidth (UVC) is the most effective sterilizing range. UVC is used in hospitals for such purposes as to sterilize surgical instruments, water, and operating room air. UV light in the A bandwidth is not typically used because of its creation of ozone at its wavelength.

UV light kills contaminants in a photochemical process. The contaminants of the types discussed above break down when exposed to high intensity UV light in a wavelength range from 240 to 290 nm. The UV light penetrates the microorganisms and breaks down the molecular bonds within the microorganism. The breaking of bonds translates into cellular or genetic damage, causing an inability to reproduce.

In contrast to kill rate effectiveness, system cost is a factor as well. It is possible but not practical to have kill rates approaching 100 per cent. To do so, air flow must typically be impeded, and very expensive systems employed. Further, higher intensity bulbs or bulbs that have specific non-standard design become increasingly more expensive as the complexity or intensity increases. Still further, systems that require external air flow assistance, such as those that provide air flow under pressure using other than forced air of a heating or cooling system, add further expense to UV systems.

For the reasons stated above, and for other reasons stated below which will become apparent to those skilled in the art upon reading and understanding the present specification, there is a need in the art for an improved air purifier.

### SUMMARY

The above-mentioned problems with air purifiers and other problems are addressed by the present invention and will be understood by reading and studying the following specification.

In one embodiment, an ultraviolet air purifier includes a housing mountable to a duct having a central opening therein, and an array of ultraviolet bulbs. Each bulb is connected to the housing and extends substantially perpendicularly from a face of the housing. The bulbs are arranged in a first direction substantially parallel to the face, and arranged in an alternating spacing in a second direction substantially perpendicular to the face.

In another embodiment, a method of purifying air in a duct includes passing contaminated air through a purifier. The purifier includes a housing, and an array of ultraviolet bulbs, each bulb connected to the housing and extending substantially perpendicular from a face thereof. The bulbs are arranged in a first direction substantially parallel to the face, and arranged in an alternating spacing in a second direction substantially perpendicular to the face.

In yet another embodiment, a method of purifying air in a duct includes arranging a number of ultraviolet bulbs in an array, each bulb extending substantially perpendicular to an air flow direction in the duct, the bulbs arranged in a first direction substantially parallel to the face, and arranged in an alternating spacing in a second direction substantially perpendicular to the face, and passing air through the duct in the vicinity of the ultraviolet bulbs.

In still another embodiment, a method of purifying air includes providing an array of ultraviolet bulbs, arranging the bulbs in a pattern of equidistant placement in one dimension and in alternating placement in a second dimension substantially perpendicular to the first dimension, and passing air flow over the array of ultraviolet bulbs.

Other embodiments are described and claimed.

### BRIEF DESCRIPTION OF DRAWINGS

FIG. 1 is a perspective view of an air purifier according to one embodiment of the present invention;

FIG. 2 is an exploded view of an air purifier embodiment and a duct in which it can be used;

FIG. 3 is a perspective view of an air duct and an installed air purifier embodiment;

FIG. 4 is a view of the air purifier of FIG. 1 taken along lines 4-4 thereof;

FIG. 5 is a view of the air purifier of FIG. 1 taken along lines 5-5 thereof;

FIG. 6 is a streamline plot of performance of an embodiment of the present invention; and

FIG. 7 is a flow chart diagram of a method according to another embodiment of the present invention.

### DETAILED DESCRIPTION

In the following detailed description of the invention, reference is made to the accompanying drawings that form a part hereof, and in which is shown, by way of illustration, specific embodiments in which the invention may be practiced. In the drawings, like numerals describe substantially similar components throughout the several views. These embodiments are described in sufficient detail to enable those skilled in the art to practice the invention. Other embodiments may be utilized and structural, logical, and electrical changes may be made without departing from the scope of the present invention.

The following detailed description is, therefore, not to be taken in a limiting sense, and the scope of the present invention is defined only by the appended claims, along with the full scope of equivalents to which such claims are entitled.

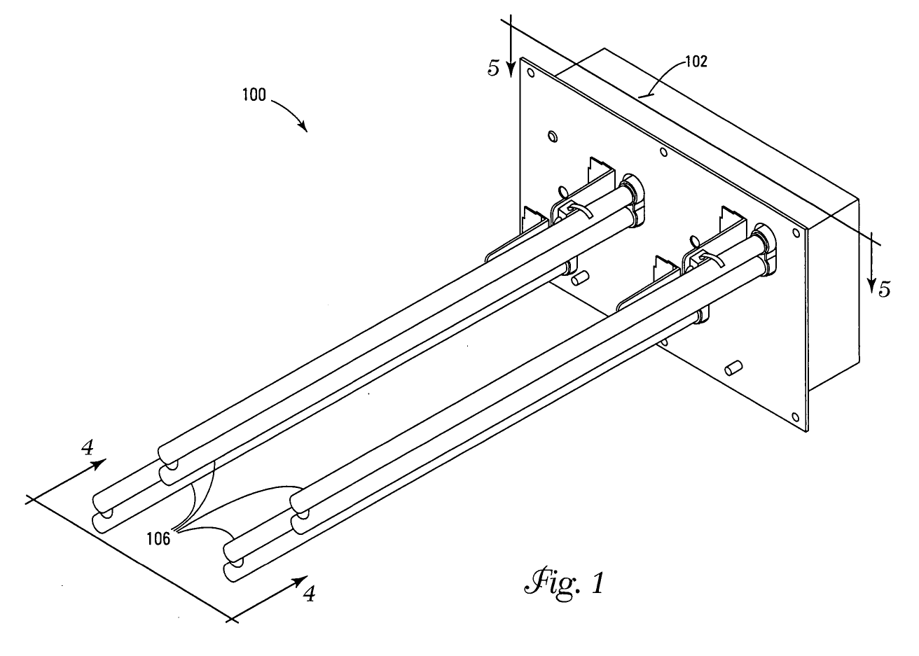

FIG. 1 is a view of one embodiment of an ultraviolet (UV) air purifier 100. Air purifier 100 comprises a casing or housing 102 that mounts to an opening created in existing duct work at a location in the duct work suitable for air purification, the casing 102 to house wiring and the like, and a plurality of UV bulbs 106 arranged in a pattern designed to improve air turbulence and to increase overall exposure of particles flowing in the duct to the UV light provided by the bulbs. The bulbs are powered by ballasts as is known in the art. The ballasts in one embodiment are housed in the casing or housing 102.

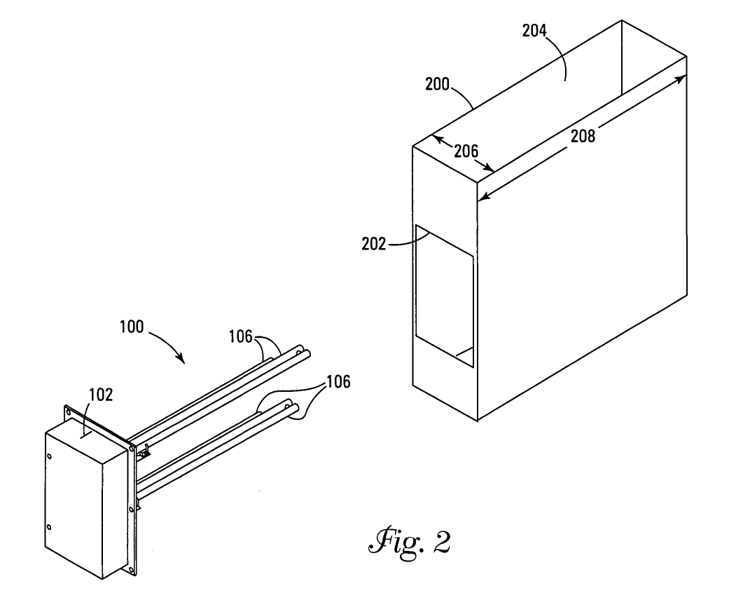

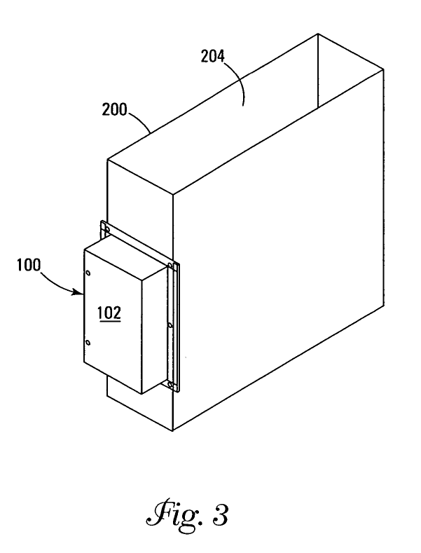

FIG. 2 is an exploded view of an air duct 200 and an air purifier such as system 100. Existing duct 200 has an opening 202 cut therein. Housing 102 of purifier system 100 is mounted to the duct 200 about opening 202, with bulbs 106 extending into the air flow cavity 204 of the duct 200. FIG. 3 shows a purifier system 100 installed into duct 200.

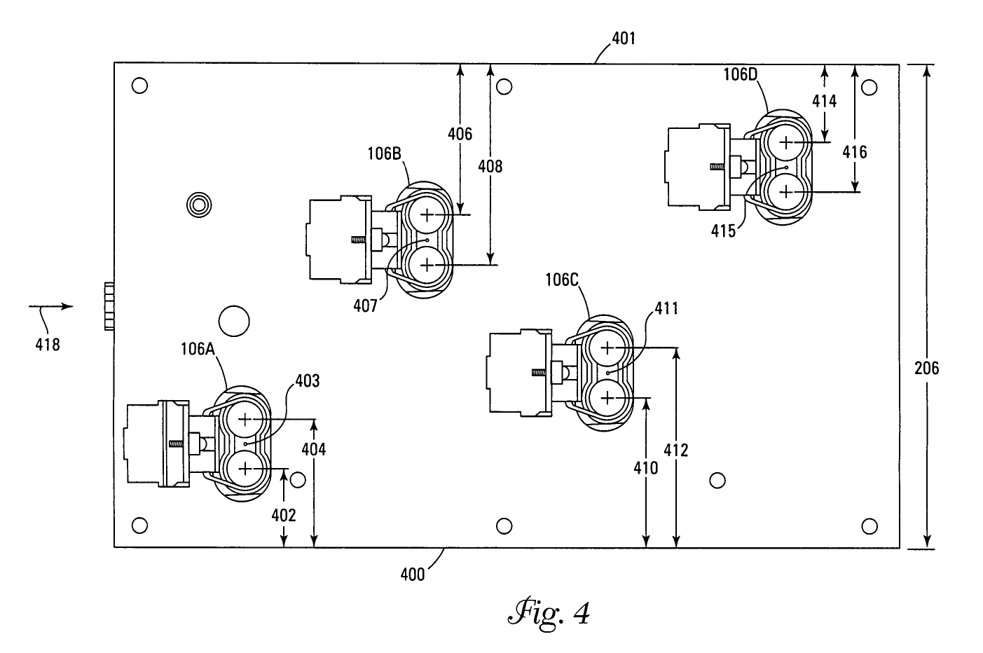

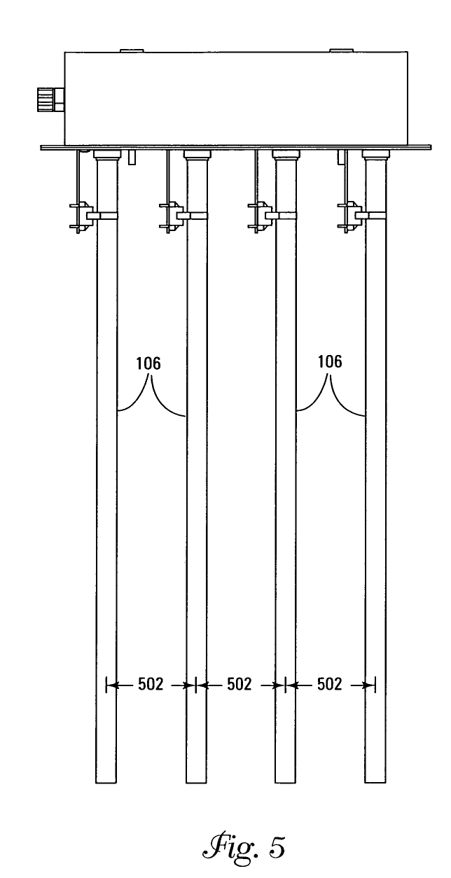

One embodiment for the arrangement of the bulbs 106 in system 100 is shown in greater detail in FIGS. 4 and 5, which are, respectively, front elevation and top views taken along lines 4-4 and 5-5 of FIG. 1. The arrangement of bulbs 106 provides a system in which air flow is directed more closely to the light sources, and is slowed down around the light sources, without substantially reducing the pressure in the system.

In one embodiment, the array of ultraviolet bulbs is each connected to the housing and extends substantially perpendicular from a face thereof. The bulbs are arranged in a first direction substantially parallel to the face, and arranged in an alternating spacing in a second direction substantially perpendicular to the face. In one embodiment, the spacing of the bulbs in the first direction is substantially equal, however, other spacings affecting air flow in the vicinity of the system 100 are within the scope of the invention.

One embodiment of the spacing is best shown in FIG. 5, where each of the bulbs 106A, 106B, 106C, and 106D is spaced apart from an adjacent bulb by a spacing gap 502. This gap 502 is substantially equal for all of the gaps in one embodiment.

The alternate spacing in one embodiment comprises an arrangement of first bulb 106A, second bulb 106B, third bulb 106C, and fourth bulb 106D. Bulb 106A is closest to an edge 400 of the housing. Bulb 106D is closest to an edge 401 of the housing. The distances of the centers 403 and 415 of bulbs 106A and 106D to the edges 400 and 401, respectively, are the same. Bulb 106B is further from the edge 400 than bulb 106A and bulb 106C, but closer to the edge 400 than bulb 106D, and is equidistant at its center 407 from opposite edge 401 as the center 411 of bulb 106C is to edge 400. Bulb 106C is further from edge 400 than bulb 106A, and is equidistant at its center 411 from edge 400 as the center 407 of bulb 106B is to edge 401.

The spacing of the bulbs 106 laterally along the axis of air flow is in one embodiment equidistant. That is, the spacing 502 shown between the bulbs in FIG. 5 is equal for all spacings. In one embodiment, the spacing 502 is approximately three (3) inches. Referring also to FIG. 4, the bulbs 106A, 106B, 106C, and 106D are shown as dual bulb lamps in an H style configuration. The spacing of the bulbs in one embodiment from the side walls of the duct is shown. The spacings 402 and 414 are equal, as are the spacings 404 and 416, the spacings 406 and 410, and the spacings 408 and 412. The spacings are shown from the respective duct wall to the center of the bulb part for each of the bulb sections, two bulb sections per H style bulb. In one embodiment, the duct width 206 is approximately eight (8) inches, the spacing 402 is approximately 1.3 inches, the spacing 404 is approximately 2.1 inches, the spacing 406 is approximately 2.5 inches, and the spacing 408 is approximately 3.4 inches. Air flow in one embodiment is directed along arrow 418 shown in FIG. 4.

Still more specifically, in one embodiment, the system uses H-style bulbs with two bulb components as shown in FIG. 1. The bulb positions are approximately three inches apart in the direction of air flow in the duct, and the bulbs are positioned as follows. Each bulb has a first and a second bulb section. The first bulb first section is centered approximately 1.3 inches from the first edge, the first bulb second section is centered approximately 2.1 inches from the first edge, the second bulb first section is centered approximately 4.6 inches from the first edge, the second bulb second section is centered approximately 5.5 inches from the first edge, the third bulb first section is centered approximately 2.5 inches from the first edge, the third bulb second section is centered approximately 3.4 inches from the first edge, the fourth bulb first section is centered approximately 5.9 inches from the first edge, and the fourth bulb second section is centered approximately 6.7 inches from the first edge.

In another embodiment, four UV lamps or lights 106A, 106B, 106C, and 106D are used in an arrangement discussed in further detail below. The bulbs are in one embodiment 36 Watt bulbs each emitting 254 nm light in the UVC band. To keep costs reasonable, this intensity of bulb is discussed in the specification. However, it should be understood that a higher intensity bulbs or non H-style bulbs, such as linear bulbs, can be used without departing from the scope of the invention. Higher intensity bulbs in the same arrangement will increase kill rates similar to an increase in kill rates for any system using higher intensity bulbs. The benefits of the present arrangements, however, are not dependent on using higher intensity bulbs, but instead on the arrangement of the bulbs to balance air flow and total light intensity incident on particles in the ventilation system.

In the event that a duct or heating system has a higher than normal air flow velocity, it should be understood that the lateral and vertical spacings discussed herein can be increased or decreased without departing from the scope of the invention. Such a spacing may be varied depending upon air flow speeds in the duct.

While H style bulbs are shown and discussed, it should be understood that different styles of bulbs and lamps are amenable to use with the embodiments of the invention, and are within its scope. For example, U style and single bulb style lamps are used in various embodiments. In the case of different bulb configurations, distances are appropriately adjusted to center the center of the H style bulb or the single bulb on the center of the two bulb configuration, generally indicated as points 403, 407, 411, and 415 in FIG. 4. If the duct size is different, spacing may change appropriately, but maintains the alternating arrangement discussed herein. Longer bulbs are used in another embodiment for wider ducts.

In another embodiment, if increased kill rates are desired, the pattern of alternating lamps discussed herein can be repeated in a different section of duct, or more lamps can be used in the same pattern over a longer housing section. Still further, multiple units can be chained together. Although it negatively affects air flow, a reflector is added in one embodiment to reflect light back toward the direction the air flow is moving from, to increase overall light intensity. The reflector is placed on the opposite side of the bulb from the air flow entry into the duct. This type of arrangement can lead to stagnant air in the vicinity of the system since the reflectors create increased blockage and restriction of air flow, canceling some of the benefits of the embodiments of the system.

The embodiments of the present invention lower velocity and decrease average distance of particles in the air flow stream to the bulbs. The way particles move in a system is calculable through application of fluid dynamics. Since particle stream is impacted by distance from bulb, we want to lower average distance from the bulbs for the maximum number of particle in the air stream. Velocity is lowered using a bulb configuration that increases turbulent air flow in the duct in the location of the system 100, but which does not significantly impede air flow within the entire ventilation system. The arrangement of bulbs does this.

Change in pressure throughput of a system is another consideration that needs to be managed. Earlier designs restricted air flow by forcing more air into narrower paths. Air flow in the duct system should be maintained in order to reduce stress on fans and blowers of furnaces.

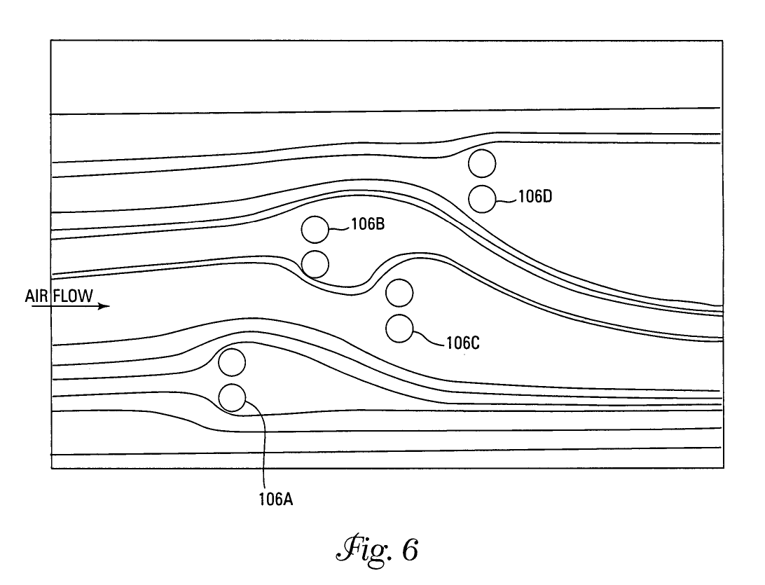

FIG. 6 is a streamline plot of air flow over the bulbs in the arrangement shown in FIG. 1-5. The streamline plot shows that while air flow is disturbed by the arrangement of bulbs 106, a majority of air streams are directed more closely to a bulb, increasing the total intensity of light incident on each particle. However, overall air flow is not significantly disturbed, that is, some air streams are deflected in one direction, and other air streams are deflected in other directions, so the total air flow in the system is not congested, which is in contrast with previous designs.

In one embodiment, the bulbs extend only partially across the width of the duct in which the system is placed. However, full width coverage of bulbs is within the scope of the invention. In another embodiment, a system that extends bulbs from each side of the duct is used. However, this system requires additional wiring to power the lights, and also requires a more complex installation. Still, the air flow patterns of such embodiments are similar to those of the above discussed embodiments, and provide similar benefits thereto.

Spacing is chosen to improve air flow while increasing turbulence, yet maintaining a housing size so as to allow the system to fit in a small space. The general layout of bulbs as shown in FIGS. 1-5 is a pattern in which air flow is in the direction shown by arrow 150 in the Figures. H style bulbs are shown in the Figures, although it should be understood that U style bulbs as well as single bulbs are also within the scope of the invention.

The spacing of the bulbs from one another laterally and from the edges of the duct provides a system in which air flow is affected by the bulbs to direct more air flow closer to the bulbs. Since kill rate for contaminants is proportional to the overall intensity of light, which is proportional to distance to the light source, overall exposure time to the light source, and intensity of the light source, that is the total light intensity incident on each contaminant. In the present embodiments, each air flow stream is subjected to a close passing to a bulb. Further, eddy currents and turbulent flow created by the spacing of the bulbs decreases air flow velocity through the area of the system, increasing average time each particle is exposed to a light source, as well as decreasing the average distance of particles to a light source. This in turn leads to a higher kill rate.

Since the overall time exposure to the light sources in increased, and velocity of air flow around the system is decreased, while total air flow restriction is low, even with a lower intensity set of bulbs, kill rate is increased. This leads to more economical and better functioning units.

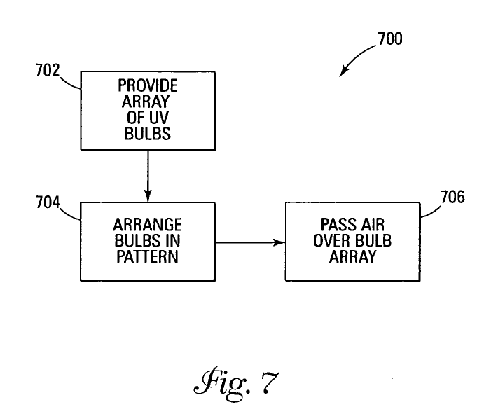

A method of purifying air using ultraviolet light in a duct is shown in flow chart form in FIG. 7. Method 700 comprises providing an array of ultraviolet bulbs in block 702, arranging the bulbs in a pattern of equidistant placement in one dimension and in alternating placement in a second dimension substantially perpendicular to the first dimension in block 704, and passing air flow over the array of ultraviolet bulbs in block 706.

Embodiments of the present invention can be installed by a user and do not require specialized knowledge of ventilation systems. One opening is made in the duct at an appropriate location, and the system can then be installed using simple tools and skills. Location of installation is a factor in the complexity of the installation. For example, previous products are installed in locations at or near where an air filter is placed in a furnace. This location requires some specialized knowledge of systems, and may require destruction of duct work and the like to create space to place the system in the desired location.

Advantages of the present embodiments include the ability to install the system from one location on a duct, without requiring wiring or cutting into more than one side of the duct. The system mounts using a single opening such as opening 202 discussed above. The unit 100 is mounted from the location of the opening 202 and can also be serviced from that opening. Further, any ballast required for powering the bulbs can be placed in the housing 104 so that no ballast is actually in the duct. This keeps substantially all of the duct interior air flow cavity obstacle free except for the UV bulbs, increasing air flow parameters.

Further advantages of the embodiments of the present invention include that the particles in the air flow streams absorb higher energy because of the lower velocity and close proximity to the UV source. This leads to an increased total intensity of light. This increased intensity can kill harder to kill contaminants that might otherwise be too difficult to kill with traditional design systems.

### CONCLUSION

Air purifiers and methods for purifying air passing through a duct have been described that include an array of ultraviolet lights arrayed in a pattern to induce turbulent air flow in the duct in the vicinity of the purifier, to increase time of exposure of contaminant particles in the air flow to light from the ultraviolet lights, and to improve kill rates for contaminants in the air flow.

Although specific embodiments have been illustrated and described herein, it will be appreciated by those of ordinary skill in the art that any arrangement, which is calculated to achieve the same purpose, may be substituted for the specific embodiment shown. This application is intended to cover any adaptations or variations of the present invention. Therefore, it is manifestly intended that this invention be limited only by the claims and the equivalents thereof.

1. An ultraviolet air purifier, comprising:
a housing mountable to a duct; and
an array of ultraviolet bulbs, each bulb connected to the housing and extending substantially perpendicular from a face thereof, the bulbs arranged in a first direction substantially parallel to the face, and arranged in an alternating spacing in a second direction substantially perpendicular to the face.

2. The air purifier of claim 1, wherein the array contains four bulbs.

3. The air purifier of claim 1, wherein the array contains at least four bulbs.

4. The air purifier of claim 1, wherein the bulbs are arranged in a first direction with substantially equal spacing.

5. The air purifier of claim 1, wherein the substantially equal spacing in the first direction is approximately 3 inches.

6. The air purifier of claim 1, wherein the alternate spacing comprises first, second, third, and fourth bulbs, the first bulb closest to a first edge of the housing, the second bulb further from the first edge than the first and third bulbs but closer to the first edge than the fourth bulb, the third bulb further from the first edge than the first bulb but closer to the first edge than the second and fourth bulbs, and the fourth bulb furthest from the first edge and equidistant from an opposite edge of the housing to the first bulb from the first edge.

7. The air purifier of claim 6, wherein the first, second, third and fourth bulbs are H-style bulbs each having a first and a second bulb section, and wherein the first bulb first section is centered approximately 1.3 inches from the first edge, the first bulb second section is centered approximately 2.1 inches from the first edge, the second bulb first section is centered approximately 4.6 inches from the first edge, the second bulb second section is centered approximately 5.5 inches from the first edge, the third bulb first section is centered approximately 2.5 inches from the first edge, the third bulb second section is centered approximately 3.4 inches from the first edge, the fourth bulb first section is centered approximately 5.9 inches from the first edge, and the fourth bulb second section centered approximately 6.7 inches from the first edge.

8. The air purifier of claim 1, wherein the bulbs are ultraviolet bulbs in a C band range of ultraviolet light.

9. The air purifier of claim 1, wherein the bulbs are H-style bulbs.

10. The air purifier of claim 1, wherein the bulbs are U-style bulbs.

11. The air purifier of claim 1, wherein the bulbs are single lamp bulbs.

12. An ultraviolet air purifier, comprising:
a housing mountable to a duct; and
first, second, third, and fourth ultraviolet bulbs, each bulb connected to the housing and extending substantially perpendicular from a face thereof, the bulbs arranged with equal spacing in a first direction substantially parallel to the face, and arranged in an alternating spacing in a second direction substantially perpendicular to the face, wherein the alternate spacing comprises first, second, third, and fourth bulbs, the first bulb closest to a first edge of the housing, the second bulb further from the first edge than the first and third bulbs but closer to the first edge than the fourth bulb, the third bulb further from the first edge than the first bulb but closer to the first edge than the second and fourth bulbs, and the fourth bulb furthest from the first edge and equidistant from an opposite edge of the housing to the first bulb from the first edge.

13. A method of purifying air in a duct, comprising:
passing contaminated air through a purifier, the purifier comprising: a housing mountable to the duct; and
an array of ultraviolet bulbs, each bulb connected to the housing and extending substantially perpendicular from a face thereof, the bulbs arranged with equal spacing in a first direction substantially parallel to the face, and arranged in an alternating spacing in a second direction substantially perpendicular to the face.

14. A method of purifying air in a duct, comprising:
arranging a plurality of ultraviolet bulbs in an array, each bulb extending substantially perpendicular to an air flow direction in the duct, the bulbs arranged with equal spacing in a first direction substantially parallel to the face, and arranged in an alternating spacing in a second direction substantially perpendicular to the face; and
passing air through the duct in the vicinity of the plurality of ultraviolet bulbs.

15. The method of claim 14, wherein the alternate spacing comprises first, second, third, and fourth bulbs, the first bulb closest to a first edge of the housing, the second bulb further from the first edge than the first and third bulbs but closer to the first edge than the fourth bulb, the third bulb further from the first edge than the first bulb but closer to the first edge than the second and fourth bulbs, and the fourth bulb furthest from the first edge and equidistant from an opposite edge of the housing to the first bulb from the first edge.

16. A method of purifying air in an air duct, comprising:
disposing a plurality of ultraviolet bulbs in the duct; arraying the bulbs in a pattern in which each bulb is connected to a housing and extends substantially perpendicular from a face thereof, the bulbs arranged in a first direction substantially parallel to the face, and arranged in an alternating spacing in a second direction substantially perpendicular to the face; and
passing air through the duct in a vicinity of the plurality of ultraviolet bulbs.

17. The method of claim 16, wherein the bulbs are arranged in a first direction with substantially equal spacing.

18. A method of purifying air in an air duct, comprising:
providing an array of ultraviolet bulbs;
arranging the bulbs in a pattern of equidistant placement in one dimension and in alternating placement in a second dimension substantially perpendicular to the first dimension; and
passing air flow over the array of ultraviolet bulbs.
